(19) United States
(12) Patent Application Publication
(10) Pub. No.: US 2009/0083260 A1
(43) Pub. Date: Mar. 26, 2009

(54) System and Method for Providing Community Network Based Video Searching and Correlation

(75) Inventors: Arturo Artom, Torino (IT); Luca Ferrero, Torino (IT); Matteo Fabiano, San Franciso, CA (US)

Correspondence Address: FLIESLER MEYER LLP, 650 CALIFORNIA STREET, 14TH FLOOR, SAN FRANCISCO, CA, 94108, US

(73) Assignee: YOUR TRUMAN SHOW, INC., San Francisco, CA (US)

(21) Appl. No.: 12/210,882

(22) Filed: Sep. 15, 2008

Related U.S. Application Data
(60) Provisional application No. 60/994,880, filed on Sep. 21, 2007.
(60) Provisional application No. 61/039,737, filed on Mar. 26, 2008.

(51) Int. Cl. G06F 7/06; G06F 17/30; G06Q 30/00

(52) U.S. Cl. 707/5; 705/14; 707/E17.001; 707/E17.014

(57) ABSTRACT

Systems and methods are described which allow a more accurate determination of relationships among videos in terms of their subject matter, context and social preferences. Rather than relying on user-specified metadata to relate videos, the present embodiments use social affinity to determine related subject matter. The process begins with a user accessing any particular video that has a unique identifier. Once the video is accessed, a list of users is found, who have added the video to their collection. From all these users, a set of all the videos that appear in their collections is compiled. Based on this information, a subset of videos which appear in a significant number of collections, can be deemed to be related to the selected video. This subset of related videos can further be analyzed to verify the metadata of the selected video and to provide suggestions and/or corrections regarding that metadata.

### CLAIM OF PRIORITY

The present application claims the benefit of the following U.S. Provisional Patent Applications:

U.S. Provisional Patent Application No. 61/039,737, entitled SYSTEM AND METHOD FOR PROVIDING COMMUNITY NETWORK BASED VIDEO SEARCHING AND CORRELATION, by Luca Ferrero et al., filed on Mar. 26, 2008 (Attorney Docket No. YTSC-01005US0), which is incorporated herein by reference in its entirety.

U.S. Provisional Patent Application No. 60/994,880, entitled VIDEO MAP APPLICATION, by Arturo Artom, filed on Sep. 21, 2007 (Attorney Docket No. YTSC-01004US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to video sharing and social networks, and more particularly to community-based and network-based video searching and video relevance and correlation assessments.

### BACKGROUND

With the ever-increasing popularity of the World Wide Web, more and more previously unrelated technologies are becoming integrated with the enormous network of information and functionality that the internet provides. Everything from television and radio to books and encyclopedias are becoming available online, amongst a wide variety of other technologies. One such area of technology, recently explosive in growth, has been various video sharing websites and services. An example of one such widely successful service is Youtube®, which allows users to upload, view and share videos, post comments, as well as interact with each other in various other ways.

While gaining popularity, the management of such video services has proven to be difficult. More particularly, the automation of searching, sorting and ranking large databases of videos, as well as accurately determining relationships amongst them, has not been a trivial process and does not lend itself to the techniques used with other types of works. For example, computerized searching, sorting and comparing of text are well known within the art. Even analysis of certain types of images and watermarks can be performed by devices having computing capabilities. However, due to their nature, videos are not so easily analyzed or compared. At its core, video can be thought of as a sequence of images that represent scenes in motion. The images can be further broken down into pixels, which can be represented as binary data. However, a video may also have context, tell a story, have certain actors, scenes and subject matter which are difficult to quantify automatically.

In general, video sharing and analysis has been dependent in large part on metadata associated with each video. Such metadata is typically specified by a user in the form of keyword tags that describe (or attempt to describe) the subject matter of the video. For example, under the Youtube® service, a video has a title, description and a set of tags, all of which are normally identified by the author (user that uploads) of the video. Based on the metadata, the system can determine potentially related videos, which can be provided as recommendations for the various users viewing a particular video. These metadata-based recommendations are based on the idea that if several videos have the same (or partially the same) metadata tags, then there is a higher likelihood that the videos are related in some way.

Numerous problems exist with this approach, however. For example, because the metadata tags are normally specified by human users, various inaccuracies and flawed associations often take place due to human error or incorrect use of terminology. One user's opinions regarding which keywords best describe the subject matter/context of the video often do not match other users'. Furthermore, metadata may not account for social preferences, trends and user tastes when suggesting relationships. Moreover, capricious or malevolent users can tag large numbers of often-unrelated keywords in order to promote particular videos, causing inconsistent associations and relationships. Because language is often ambiguous, even proper and correct tagging can result in misinterpretations. As an illustration, a video about computers tagged with the word “Apple” could be mistakenly linked to videos about a type of fruit. A multitude of other such ambiguities and issues can be found within this context.

Large amounts of research and capital has gone into analyzing video in order to improve marketing and advertising, advance automation and generally provide a better user experience. Certain specific techniques have been employed to resolve some of the issues described above. However, various problems still exist and a new approach for video analysis is desirable. Applicants have identified these, as well as other needs that currently exist in the art in coming to conceive the subject matter of the present disclosure.

### BRIEF DESCRIPTION OF THE DRAWINGS

FIG. 1 is a high level illustration of relationships among users and videos, in accordance with various embodiments.

FIG. 2 is a high level illustration of metadata relationships among users and videos, in accordance with various embodiments.

FIG. 3 is a high level illustration of keyword verification and suggestions used in conjunction with online advertising, in accordance with various embodiments.

FIG. 4 is an example flow chart diagram of a process for providing video searching and correlation, in accordance with various embodiments.

FIG. 5 is an example flow chart diagram of a process for providing video searching and correlation, in accordance with various embodiments.

FIG. 6 is an example flow chart diagram of using the social affinity-based correlation process in order to analyze and verify video metadata, in accordance with various embodiments.

FIG. 7 is an illustration of a system-level example, in accordance with various embodiments.

FIG. 8 is an illustration of a user interface that can be used to navigate related videos, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details will be set forth to provide a thorough description of the invention. However, it will be apparent to those skilled in the art that the invention may be practiced without these specific details. For example, while the preferred embodiments are described herein within the context of videos, it will be apparent to one skilled in the art that these processes and techniques can also be used in conjunction with various other fields, such as music, graphics, media and/or other technologies.

In accordance with various embodiments, there are provided systems and methods for community and network based video searching and correlation. The system can include a database of a plurality of videos which have been authored or uploaded by various users. Some or all of the users can have designated sets or personal collections of videos which have been designated based the user performing a particular action. In one embodiment, the collection of videos is the videos that the particular user has placed into his or her Favorites list. In other embodiments, the collection of videos can be designated by the user performing other actions, such as rating the videos a particular rating, playing the videos, reviewing the videos, adding videos to a personal channel/play list, or performing any other action that creates a particular video set of some interest.

The process can be initiated by accessing the database and selecting a particular video. The selection can be performed by a user or by a computer program. The video can be identifiable by a unique ID, such as a uniform resource locator (URL) or a sequence of characters. Based on this unique identifier, a list is compiled of all the users that are associated with the selected video in the sense that each user in the list has designated the selected video by adding it to their personal collection (e.g. list of Favorites).

Once this list of users is compiled, the collections of videos of each user in the list can be analyzed for videos which are related to the selected video. In one embodiment, the video is related if it resides in a specified number of users' collections. For example, if a video (which is different from the selected video) is also present in the collections of at least two or more users in the list, then it can be assumed that the video has some likelihood of being related to the selected video. In various embodiments, the higher the number of occurrences, the higher is the likelihood that the video will be related in terms of subject matter or context to the selected video. For example, if 80 percent of the users that have the selected video X in their collection, also have video Y, there can be a very high likelihood that video X and video Y are related in terms of subject matter and/or interest. In this case, video Y is said to have an 80 percent correlation to video X. This relevance effect is especially evident across large databases of users with numerous videos being grouped into selected sets. In fact, in larger databases (e.g. one hundred thousand videos or more) even low correlation percentages have yielded positive relevance results. For example, across these large databases correlation of as low as 4-5 percent have shown that the videos are very likely to be related in terms of subject matter on some level. The specific threshold correlation limit of a video may be dependent on the size of the database, the general popularity of the content, as well as various other factors. Thus, in one embodiment, the threshold is a variable (e.g. number or percentage value) that is configurable by a user. For example, the threshold can be set at 5 percent correlation. In that case, only those videos which appear in the collections of at least 5 percent of all users in the list would be considered relevant. Once identified, these related videos can be presented to the user as suggestions or recommendations, or used in various other ways, as will be described below.

Notably, this process for determining correlation can be completely independent of any metadata tags associated with the videos. Because the process evaluates the social affinity of the video in the context of user-generated content, no tags or metadata is necessary to determine the relevance of one video to another. While useful for many purposes, video metadata can often be incorrect or misrepresent the subject matter of the content in the video. Accordingly, the process can actually be used as a tool to verify or check the metadata for any particular video. In other embodiments, the process can also be used to disambiguate the metadata tags which may be ambiguous (“apple” the fruit vs. “Apple” the computer, etc.).

In various embodiments, the metadata of a video can be verified by analyzing the keyword tags of the related videos which have appeared in a high number of users' collections. Once the set of related videos is determined, as discussed above, the metadata of all the related videos can be inspected and compared to the metadata used to tag the selected video. In order to do this, a set of related metadata keywords can be derived from all of the related videos. This set of related metadata can be weighted by the number of related videos that each keyword appears in. For example, since it is unlikely that all of the keywords in the related set would be relevant or accurately describe the subject matter of the video, only those keywords which appear a sufficiently high number of times and which are descriptive enough should be used in this comparative analysis. This can be done by first removing very common and relatively non-descriptive words such as “a”, “the”, “in”, “of” and the like from the set of keywords. Next, a new threshold can be set, i.e. the metadata correlation threshold. In one embodiment, this metadata correlation threshold is a configurable variable or value that specifies a minimum number of occurrences of the keyword before that keyword is deemed accurate (relevant to the subject matter of the video). For example, the metadata correlation threshold can be set at 5 percent. Consequently, only those keywords which appear in 5 percent or more of the related videos would be compared against the actual metadata used to tag the video when performing the metadata validation. If the keywords match (or mostly match), the metadata for the video can be deemed to be valid. If the keywords do not match, the metadata of the related videos can be suggested or used instead.

More specifically, in one embodiment, the keywords used to tag the video “match” if they appear in the related set of keywords. The degree to which the keywords match can also be considered. For example, if a keyword used to tag the video also appears in 23% of the related videos, it can be said to strongly match the content of the video, while keywords appearing in only 1% of the related videos may provide only a weak match.

In various embodiments, if the keywords of the video match the related set to a certain degree, they can be deemed to be valid. If they do not match, they can be considered invalid. This metadata validation feature can provide significant advantages, as described throughout this disclosure.

In some embodiments, the system also provides metadata suggestion and replacement. For example, if the keywords used to tag the video do not match the related set (and thus is invalid), a new set of keywords can be suggested. Alternatively, the keywords of the video can be automatically replaced by the keywords which are deemed more relevant. In one embodiment, the suggested (or replacement) keywords can be those keywords which appear in the sufficient percentage of the related videos.

This kind of metadata validation can be implemented within the context of serving electronic advertisements (ads) on the internet Typically, ad engines evaluate the metadata of the video (or web page) and serve an advertisement based on that metadata. For example, if the video is tagged with keywords such as “travel,” “tourism,” or “getaway destinations,” an ad engine may serve an ad for booking airline flights or hotels. However, if the metadata is ambiguous or inaccurate, the served advertisement would not match the subject matter of the video, leading to lost revenues and profits. In this case, the metadata verification can be used to generate suggestions to the ad engine so as to increase the probability that the ad served will accurately reflect the subject matter of the video. For example, a metadata validation software module can be created, which will be invoked just before serving an ad on a video page. If the module determines that the metadata is not accurate, it can feed an alternative set of keywords to the ad engine as a recommendation. These alternative keywords can be used by the ad engine to modify, add or replace advertisements accordingly.

It should be noted that extremely popular content and keywords may affect the process for determining correlation that was previously described. For example, a video can be extremely popular among users because it was very well publicized. In that case, it is quite possible that this video will be found in many users' collections simply due to its extreme popularity, rather than the subject matter relationships to other videos. An example of this may be a funny video that is placed on the home page of the video service website or widely publicized on a national television commercial, news, etc. This video would be much more likely to be found in many users' Favorites collections due to its popularity rather than its subject matter. In one embodiment, to compensate for this effect, the most popular videos can be eliminated from the algorithm altogether. Alternatively, the videos can be weighted inversely to their popularity. This can be implemented in a variety of ways. For example, a related video can be assigned a weight of less relevance if it has been viewed a substantially higher number of times than another related video. Alternatively, popular videos that appear in very large numbers of users' Favorites across the entire database could be weighted with less relevance than videos which are uncommon but still determined to be related using the process described above.

A similar technique can be implemented with overly popular keyword metadata tags. For example, some keywords, such as “video” may be too popular and too generic to express anything about the actual content of the video. Accordingly, these keywords can be removed from consideration or weighted according to popularity. Furthermore, some keywords can be classified into taxonomies that identify the genre of the video rather than its specific content. For example, keywords such as “comedy,” “music” or “funny” identify the genre of the video and thus may not be as applicable when determining the relationship of content. Once again these videos can be weighted, removed or used in a different manner from other keywords.

The various embodiments will now be described in conjunction with the figures discussed below. It is noted, however, that the figures and accompanying descriptions are not intended to limit the scope of the invention and are provided for purposes of clarity and illustration.

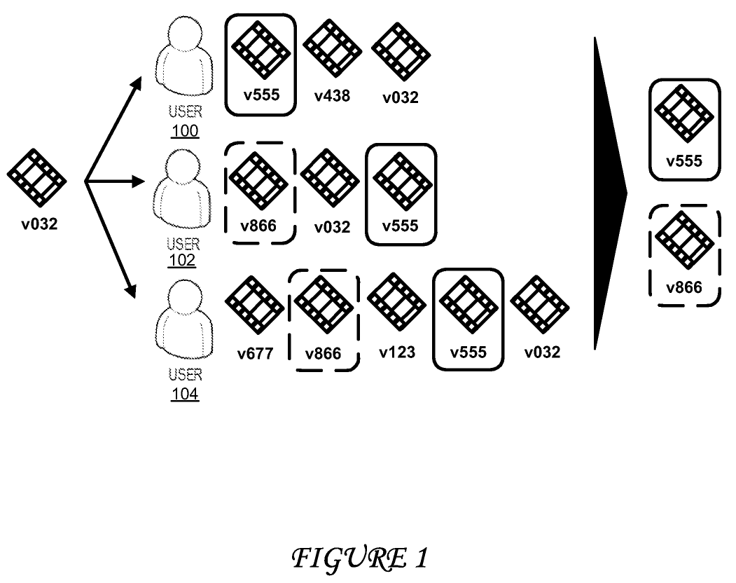

FIG. 1 is a high level illustration of relationships among users and videos, in accordance with various embodiments. Although this diagram depicts a certain number of components, such depiction is merely for illustrative purposes. It will be apparent to one skilled in the art that the ideas illustrated herein can be implemented in a substantially larger number of videos and users. Furthermore, it will also be apparent to one of ordinary skill in the art that users and videos can be interchanged or removed from this figure without departing from the scope of the various embodiments.

As illustrated, the relationships can be based on a single video v032 and all of the users which have chosen the video v032 to be in their collection. In one embodiment, users, 100, 102 and 104 have each added video v032 into their Favorites list. In addition to video v032, user 100 has also added videos v555 and v438 to his or her collection. Similarly, user 102 has added videos v866 and v555 and user 104 has added videos v677, v866, v123 and v555 in addition to video v032. Notably, while the collection used here is a Favorites list, this disclosure is not intended to be limited to such an implementation. In alternative embodiments, the users 100, 102 and 104 may have added video v032 to a personal play list or channel, rated video v032 a specific rating, reviewed video v032, played it, or performed some other action that expresses user interest of some degree.

As shown, for any given video, the system can first compile a list of all the users which have designated the selected video v032 to be in their collection. In this particular illustration, the list would comprise user 100, user 102 and user 104. Once the list of users is obtained, the collections of each user in the list can be inspected in order to look for videos which appear in multiple collections. For example, as shown in FIG. 1, in addition to video v032, video v555 also appears in every single collection of users 100, 102 and 104. Thus, video v555 can be said to have one hundred (100) percent correlation with video v032. As further shown, video v866 appears in the collections of user 102 and user 104 but not in the collection of user 100. Since video v866 appears in two out of the three collections, it is said to have 66.67 percent correlation with video v032. Videos v438, v123 and v677, on the other hand only appear in one of the collections and thus can be deemed to be less likely related to video v032.

A correlation threshold can be set up to determine the related videos. For example, if the threshold is set at 50 percent correlation, videos v555 and v866 would be deemed to be related to video v032. These related videos can then be provided as a recommendation or suggestion to any user that is viewing video v032, as well as used in various other ways.

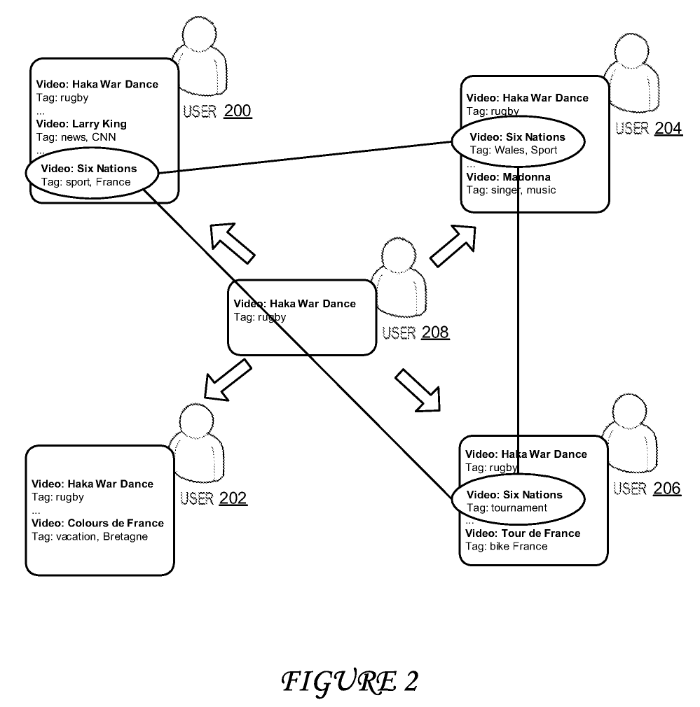

FIG. 2 is a high level illustration of metadata relationships among users and videos, in accordance with various embodiments. Although this diagram depicts a certain number of components, such depiction is merely for illustrative purposes. It will be apparent to one skilled in the art that the ideas illustrated herein can be implemented in a substantially larger number of videos, users and metadata. Furthermore, it will also be apparent to one of ordinary skill in the art that certain users, videos and metadata can be changed or removed from this figure without departing from the scope of the various embodiments.

In the example illustrated, user 208 has uploaded a video entitled “Haka War Dance” and has tagged it with a metadata keyword “rugby.” Users 200, 202, 204 and 206 have each added video “Haka War Dance” to their collections. As such, the first step of the algorithm would yield a list of users 200, 202, 204 and 206 and the set of all videos that can be found in their collections.

Continuing with the illustration, the next step can determine which videos are more common among the collections than others (which videos appear in multiple users' collections). As can be seen, the video entitled “Six Nations” is found in the collections of users 200, 204 and 206. Accordingly, in one embodiment, the algorithm would correlate the “Six Nations” video to the “Haka War Dance” video and, consequently to the keyword “rugby.”

In this illustration, a common keyword-based search would not find the “Six Nations” video because the word “rugby” does not appear among the tags that “Six Nations” was tagged with. For the same reasons, a metadata-based relevance determination for related videos would not bring up the video “Six Nations.” However, because the algorithm described herein ignores any metadata in determining relevance, relying only on social affinity, it is able to identify related results that a simple keyword search would miss. In addition, the metadata for the “Haka War Dance” video can be verified by comparing the keywords used to tag this video with the keywords used to tag the related video “Six Nations.”

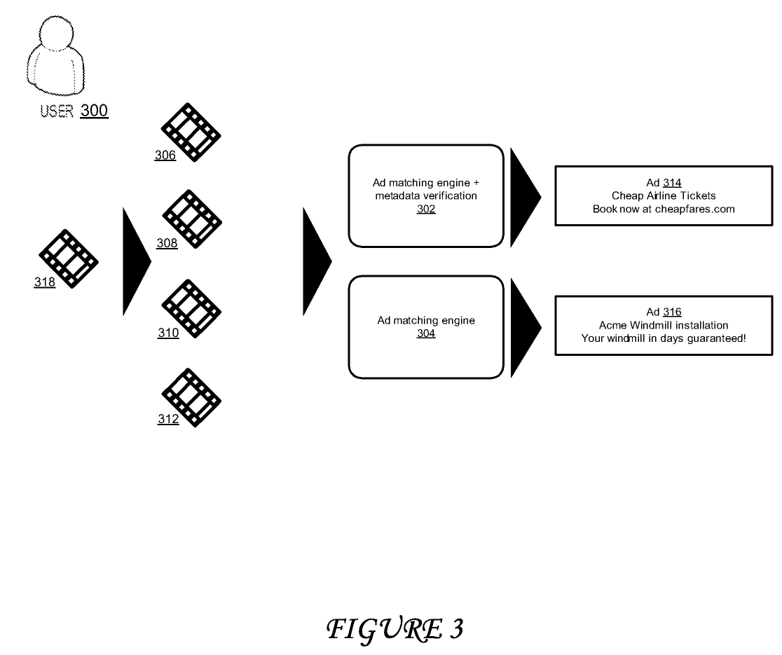

FIG. 3 is a high level illustration of metadata verification and suggestions used in conjunction with online advertising, in accordance with various embodiments. Although this diagram depicts a certain number of components, such depiction is merely for illustrative purposes. It will be apparent to one skilled in the art that the ideas illustrated herein can be implemented in a substantially larger number of videos, users and metadata. Furthermore, it will also be apparent to one of ordinary skill in the art that certain users, videos and metadata can be changed or removed from this figure without departing from the scope of the various embodiments.

As illustrated, user 300 can access any given video in the database, such as video 318. In this particular example, video 318 has been tagged with the keywords “windmill” and “road.” However, in this example, video 318 was recorded by a tourist during a trip abroad and was tagged with these particular keywords because the windmill and road were recorded in the video. A standard metadata-based ad-matching engine 304 would read the keywords “windmill” and “road” and select a particular advertisement for these keywords, thereby yielding an ad 316 for “Acme Windmill installation.” However, these metadata keywords, while describing some portion of the subject matter of the video, may not properly capture the context of that subject matter as a whole.

The metadata verification and social affinity-based relevance process, on the other hand, yields related videos 306, 308, 310 and 312. As evident from the keywords, these related videos deal with the subject matter of travel and have been tagged as such. For example, the keyword “travel” appears in all four of the related videos (metadata correlation of 100 percent). The tag “vacation” appears in two of the four related videos (50 percent correlation), similarly to the keywords “train” and “roadtrip.” As shown in the figure, the metadata verification-based algorithm would produce these more accurate keywords and suggest them to the ad matching engine 302. Based on these keywords, the ad engine can instead serve an ad 314 for “Cheap Airline Tickets,” providing a better targeted advertisement, taking into account the context of the video. In this manner, the ad engine is improved to better match ads (tagged with poor or inaccurate metadata) to the content of the video, as well as the specific audience social profile and preferences.

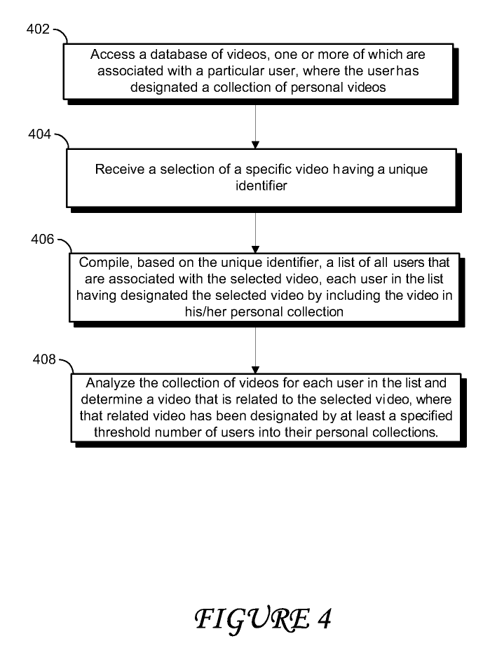

FIG. 4 is a high level flow chart diagram of a process for providing video searching and correlation, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. It will also be apparent that certain steps can be added to or omitted from the process without departing from the scope of the various embodiments.

As shown in step 402, the process can begin by accessing a database of videos, one or more of which are associated with a particular user. In the preferred embodiment, a single user can be considered an author of the video because the user has uploaded the video to the database. Furthermore, some or all of the users can have collections of videos from the database, which they have designated, such as by adding the videos to their personal Favorites list. It should be noted that the term “database” as used throughout this application is intended to be broadly construed to mean any type of persistent electronic storage, including but not limited to relational database management systems (RDBMS), repositories, hard drives, and servers.

In step 404, a video having a unique identifier is selected. The selection can be performed by a human user or by a computer program such as a client application. In step 406, based on the unique identifier of the video, a list of all the users that have the video in their collection is compiled. In one embodiment, this list of users would include all users that have added the video to their personal list of favorites. In other embodiments, the list would include all users that have rated the video a specific rating, added the video to a channel/play list, reviewed the video and the like.

In step 408, the videos of all of these users can be analyzed in order to determine at least one video that is related to the selected video. This analysis can be done by setting a video correlation threshold and then selecting those videos which have appeared at least the threshold number of times in the users' collections. For example, if the threshold is set at 5 percent correlation, then those videos which have appeared in the collections of at least 5 percent of the users would be deemed related. The related videos can then be provided as recommendations to various users or used to analyze metadata as described below.

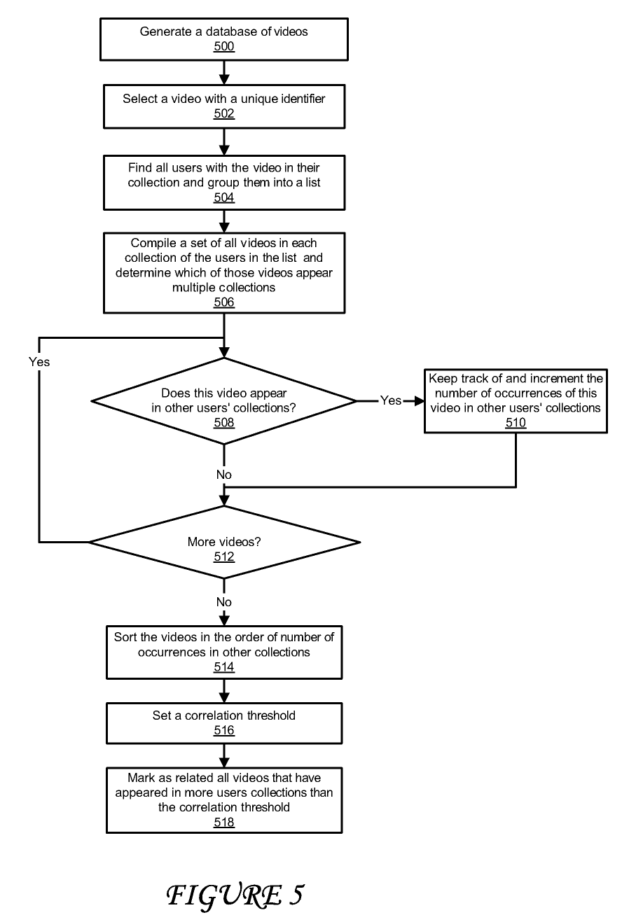

FIG. 5 is an example flow chart diagram of a process for providing video searching and correlation, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. It will also be apparent that certain steps can be added to or omitted from the process without departing from the scope of the various embodiments.

As shown in step 500, the process begins with generating a database of videos. The videos typically have been uploaded to the database by a plurality of users. In step 502, a video with a unique identifier is selected. In one embodiment, the unique identifier (ID) is a uniform resource locator (URL). In other embodiments, the unique ID can be a number or a string of characters that uniquely identify the selected video. Based on this ID, the process can find all of the users that have the video in their collection, as shown in step 504. These users can be grouped into a list of users that have expressed some interest in the selected video.

In step 506, a set of all the videos that appear in the collections of these users is compiled. In other words, the compiled set of videos includes every video that appears in the collection of at least one user in the group that has expressed the interest in the selected video. From this set, it can then be determined which of those videos appear in more than one collection.

As shown in step 508, it is determined whether each video appears in other user's collection. If it does not, then it is unlikely that this video will be related to the selected video with the unique identifier and other videos can be analyzed (step 512). However, if the video does appear in other collections, it is more likely that this video is related in terms of subject matter and therefore it is desirable to keep track of and increment the number of the occurrences, as shown in step 510. Once it is determined which videos are found in other collections, they can be sorted in order based on the number of occurrences in the other users' collections (step 514).

In step 516, a correlation threshold is set. The correlation threshold can be a configurable variable that is expressed as a number, a percentage or the like. The variable can be set by a user, an administrator or automatically determined by a client application. In any case, the correlation threshold will set the cut off point for videos to be deemed related in terms of subject matter to the video that was originally selected in step 502. For example, if the threshold is set at five (5) percent correlation, only those videos that appear in the collections of at least 5 percent of the users in the group will be deemed related. In other words, the videos that appear in more collections than the correlation threshold will be considered to be related to the selected video in terms of subject matter and/or context.

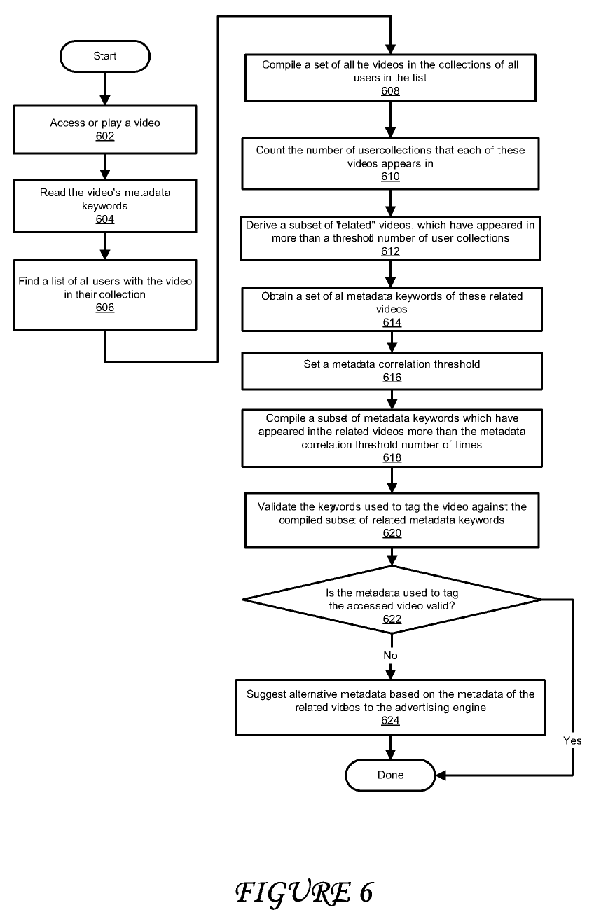

FIG. 6 is an example flow chart diagram of using the social affinity-based correlation process in order to analyze and verify video metadata, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. It will also be apparent that certain steps can be added to or omitted from the process without departing from the scope of the various embodiments.

The process can begin by a user accessing any given video, as shown in step 602. For example, a user may play the video by clicking on a standard URL-based link. In step 604, the metadata (e.g. keywords) used to tag the video can be read, for use in the analysis later. In step 606, based on the unique ID of the video, a list of all users can be found, which have added the video to their personal list of favorites or some other form of collection, as previously described. Based on this grouping of users, in step 608, all the videos that are found in the collections of the group are compiled into a set. In step 610, it is determined how many collections each of these videos appears in. Based on this information, a subset of “related” videos is derived by setting the correlation threshold, as shown in step 612. The videos that appear in more collections than the threshold limit are considered related.

In step 614, a set of all the metadata keywords is retrieved for the related videos. This can be done by reading each metadata tag for each video in the subset of related videos. In step 616, a metadata correlation threshold can be set. In one embodiment, this is a different threshold variable from the video correlation threshold that is used in step 612. In alternative embodiments, both thresholds can be the same variable. In either case, the metadata threshold is used to limit the number of metadata keywords or terms that will be deemed relevant or “accurate” to the subject matter of the video. Thus, in step 618, a subset of metadata keywords is compiled, which have appeared in the related videos more than the metadata correlation threshold number of times. As an illustration, if the word “travel” appears in more than 10 percent of the related videos, it can be deemed to be a related keyword even if it does not appear in the metadata of the actual video itself.

In step 620, the keywords used to tag the video (obtained in step 604) are validated against the subset of related keywords in order to determine the degree of similarity between the two sets of metadata. Based on this comparison, it can be determined whether the metadata used to tag the video is valid, as shown in step 622. For example, those tags from the video which appear in the subset of related keywords can be deemed to be valid. Those tags which do not appear in the subset related keywords, on the other hand, can be deemed invalid. Accordingly, the process provides a way to verify the metadata tags of any video.

In addition, if the metadata of the selected video does not match the metadata of the related videos, an alternative set of metadata can be suggested, as shown in step 624. In one embodiment, some of the subset of related keywords can be provided as a recommendation to an online advertisement engine as a replacement to the keywords actually used to tag the video. For example, the most commonly occurring (highest correlation) keywords can be suggested to the ad engine in step 624.

One application of the verification process is to merely merge the set of related metadata collected from the related videos with the metadata originally used to tag the video and to provide the merged set to the ad engine. However certain metadata keywords are too generic or too popular and it may be desirable to remove them. For example, keywords such as “video” are generally too popular to obtain a correct description of the subject matter therein. Similarly, words such as “in,” “at,” “the” and the like are typically non-descriptive and can also be removed. Furthermore, certain words such as “funny” or “drama” typically describe a genre of the video, rather than its actual content and as such, these words can be either removed or weighted differently from the others.

Another optimization technique can be to determine the degree of correlation between each keyword in the related set of keywords and the set of all related keywords as a whole. In certain embodiments, this optimization of the related metadata set can be used to eliminate the keywords which are less accurate or less related. For example, if keyword X correlates better with the set of related metadata as a whole than keyword Y, then keyword X can be considered more accurate metadata than keyword Y. In one embodiment, the most accurate keywords can be provided to the ad engine. In another embodiment, the least accurate keywords can be removed from the set of metadata before providing the set to the ad engine. This optimization can also be made configurable by a user.

Another application of the metadata verification process is to use the set of related metadata collected from the related videos in order to tag the original video in a more optimal manner. This can be used to supplement the tags or to re-tag videos that have been poorly tagged or that do not contain any keyword tags to describe their content. By using the verifications described above, a set of the most relevant tags (having the highest metadata correlation) can be extracted from the set of related videos and these most relevant tags can be used to tag the selected video. This set of most relevant tags can also be optimized using the optimization techniques described above in order to further improve the accuracy of the metadata tags.

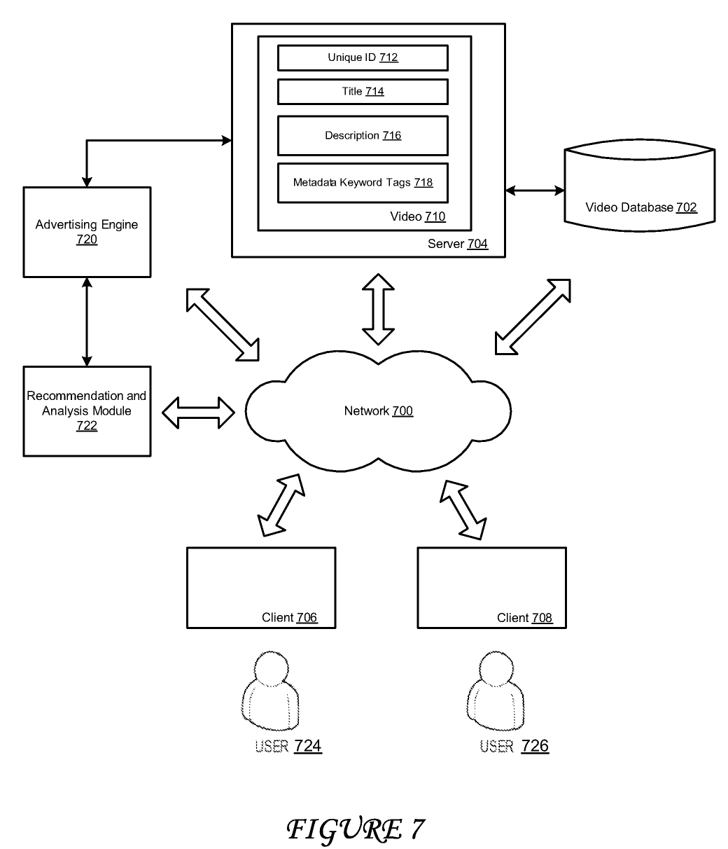

FIG. 7 is an illustration of a system-level example, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Such components, regardless of how they are combined or divided, can execute on the same computing device or can be distributed among different computing devices connected by one or more networks or other suitable communication means. Furthermore, it will also be apparent to one of ordinary skill in the art that certain components can be added, interchanged or removed from this figure without departing from the scope of the various embodiments.

As illustrated, the system can include a server 704 connected to a network 700 for providing videos and other media to various users 724, 726 via client computers and other devices 706, 708. The server can maintain access to a database 702 of videos, such as video 710, and provide access to these videos for the users. In one embodiment, each video can have a set of information associated therewith, such as the unique ID 712, the title 714, the description 716, and the metadata keyword tags 718. In various embodiments, some of this information is created by the user that uploads the video to the server, while other portions of the information is automatically generated by the server 704.

An advertising (ad) engine 720 can serve electronic advertisements in conjunction with the server 704. In one embodiment, when a user 724 accesses a video 710, the advertising engine evaluates the metadata 714, 716, 718 of the video and serves an advertisement to the user 724 based on that metadata.

The recommendation and analysis module 722 can carry out the processes described in connection with FIGS. 4-6 in order to provide recommendations to the ad engine 720. For example, the recommendation and analysis module can suggest alternative or additional metadata to use when serving the ad. It should be noted that while the recommendation and analysis module is illustrated as a separate stand-alone component, this is done purely for purposes of clarity and should not be construed to limit this disclosure. In various other embodiments, the recommendation and analysis module 722 can also be integrated with the server 704 or the ad engine 720, deployed on the clients 706, 708 or implemented in some other way. Similarly, the recommendation module 722 can interoperate with multiple servers, ad engines clients and databases, as well as other components.

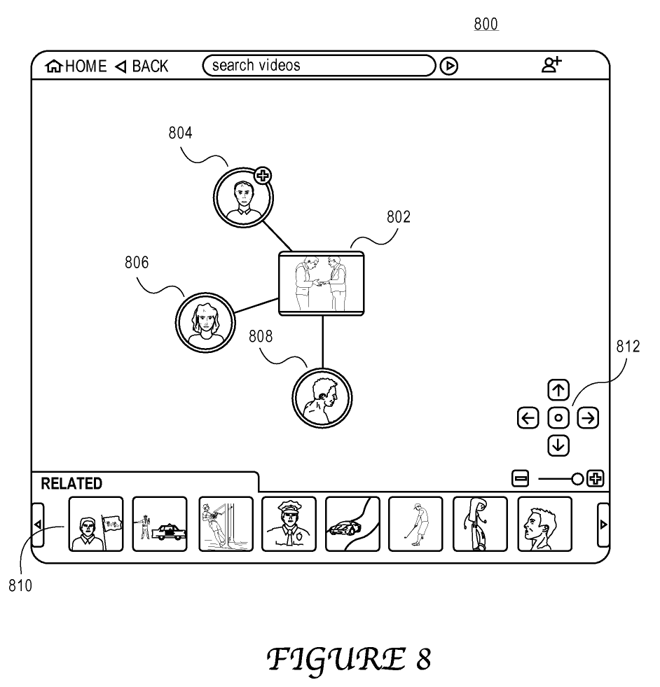

FIG. 8 is an illustration of a user interface that can be used to navigate related videos, in accordance with various embodiments. Although this diagram depicts components as logically separate, such depiction is merely for illustrative purposes. It will be apparent to those skilled in the art that the components portrayed in this figure can be arbitrarily combined or divided into separate elements on the display screen. Furthermore, it will also be apparent to one of ordinary skill in the art that certain components can be added, interchanged or removed from this figure without departing from the scope of the various embodiments.

As illustrated, the user interface 800 can be used to display the results of the various processes for video searching and relevance assessment described above. In various embodiments, the user interface 800 is displayed on a graphical screen such as a display of a personal computer, laptop, personal digital assistant (PDA), a cellular phone or a similar device. As shown in FIG. 8, the selected video 802 can be displayed as a rectangular icon in the center of the interface screen. Linked to this video icon are all the users 804, 806 and 808, who have added the video 802 to their personal collections. In one embodiment, a click on one of the user icons will bring up the videos that that particular user has in their collection.

Furthermore, the related videos which are found in the collections of the users 804, 806, and 808 are displayed in-line at the bottom banner 810 of the user interface 800. In the preferred embodiment, the related videos are arranged from left to right by their degree of correlation, with the highest correlation videos being listed first in line. Thus, a video with 30 percent correlation to the related video would be displayed before a video with only 3 percent correlation. In addition, a navigation panel 812 allows the user to navigate the users and videos displayed on the user interface 800.

The user interface 800 allows users to navigate the relationships among users and videos in a simple and straightforward manner. This particular implementation allows users to visualize the relationship between videos and users in a clear and complete way, without having to continuously navigate from video to video. In this manner, the user interface 800 can be a useful tool to display the results of the processes described herein.

As used throughout this disclosure, the term metadata is intended to be broadly construed, to mean any form of information, data, metadata or meta-metadata which describes the video or its content. In various embodiments, the metadata is all contextual information apart from the unique identifier of the video, including but not limited to the title of the video, the description and the keyword tags. The term database is intended to be broadly construed to mean any type of persistent storage of the video, including but not limited to relational databases, repositories, file systems and other forms of electronic storage. The term list is intended to be broadly construed to mean any type of grouping of users or other components including but not limited to joined sets, tables, lists, unions, queues and other groups. The term collection is intended to be broadly construed to mean the grouping of videos or other media that the user(s) has expressed some interest in, including but not limited to personal favorites lists, play lists, channels, rated videos, reviewed videos and/or viewed videos. The terms module and engine can be used interchangeably and are intended to be broadly construed to mean any type of software, hardware or firmware component that can execute various functionality described herein. For example, a module includes but is not limited to a software application, a bean, a class, a webpage, a function and/or any combination thereof. Furthermore, a module can be comprised of multiple modules or can be combined with other modules to perform the desired functionality. The term network is intended to be broadly construed to mean any form of connection(s) that allows various components to communicate, including but not limited to, wide area networks (WANs), such as the internet, local area networks (LANs) and cellular and other wireless communications networks.

Various embodiments described above include a computer program product which is a storage medium (media) having instructions stored thereon/in and which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. The instructions can be stored on the computer-readable medium and can be retrieved and executed by one or more processors. Some examples of such instructions include but are not limited to software, firmware, programming language statements, assembly language statements and machine code. The instructions are operational when executed by the one or more processors to direct the processor(s) to operate in accordance with the various embodiments described throughout this specification. Generally, persons skilled in the art are familiar with the instructions, processor(s) and various forms of computer-readable medium (media).

Various embodiments further include a computer program product that can be transmitted in whole or in parts and over one or more public and/or private networks wherein the transmission includes instructions which can be used by one or more processors to perform any of the features presented herein. In some embodiments, the transmission may include a plurality of separate transmissions.

Stored one or more of the computer readable medium (media), the embodiments of the present disclosure can also include software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments and containers, virtual machines, as well as user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for providing social affinity based searching and correlation, said method comprising:
accessing a video from a database that stores a plurality of videos, one or more of the plurality of videos being associated with at least one user, the user having a collection of videos designated by said user;
reading a keyword for said video;
compiling a list of all users that are associated with the video, each user in said list having designated the selected video to be in said each user's collection of videos;
analyzing the collection of videos for each user in the list and determining a subset of related videos, said subset of related videos having been designated by at least a specified threshold number of users in said list;
retrieving a set of related keywords from the subset of related videos; and
validating the keyword of the video against the set of related keywords retrieved from the subset of related videos.

2. The method of claim 1, further comprising:
determining that the keyword of said video is not valid; and
generating a set of suggested keywords for replacing the keyword of said video.

3. The method of claim 1, wherein validating the keyword of the video further includes:
determining whether the keyword for said video appears in the set of related keywords retrieved from the subset of related videos.

4. The method of claim 1, wherein retrieving a set of related keywords from the subset of related videos further includes:
setting a metadata correlation threshold; and
compiling keywords which have appeared in the subset of related videos more than the metadata correlation threshold number of times.

5. The method of claim 1, wherein the metadata correlation threshold is a configurable variable.

6. The method of claim 1, further comprising:
suggesting alternative metadata to one or more ad engines if the keyword for said video is determined to be invalid, wherein the suggested alternative metadata is based on the set of related keywords.

7. The method of claim 1, wherein the step of determining the subset of related videos is performed independent of any metadata associated with the video.

8. The method of claim 1, further comprising:
correlating, with the video, at least one other video such that the metadata of said other video does not match the metadata for said video.

9. The method of claim 1, wherein the collection of videos for each user is designated by the user performing at least one of the following:
adding videos to a favorites list, adding the videos to a channel, adding the videos to a personal play list, reviewing the videos, playing the videos, voting on the videos and rating the videos a specified rating.

10. The method of claim 1, wherein the specified threshold number of users is a configurable variable that is two or more users.

11. A system for providing social affinity based video searching and correlation, said system comprising:
a database that stores a plurality of videos, one or more of the plurality of videos being associated with at least one user, the user having designated a subset of the plurality of videos in a collection; and
a relevance module that receives a selection of a specific video, compiles a list of all users that have the specific video in their collection and determines a set of related videos for said specific video, wherein each of the related videos has been designated in the collection by at least a threshold number of users; and
an advertisement engine that serves one or more electronic advertisements wherein the advertisement engine receives a suggestion from said relevance module and modifies the electronic advertisements according to said suggestion, the suggestion being based on the set of related videos.

12. An apparatus connectable to a network for providing video searching and correlation, said apparatus comprising a computer readable medium and at least one processor that performs the steps of:
accessing a video from a database that stores a plurality of videos, one or more of the plurality of videos being associated with at least one user, the user having a collection of videos designated by said user;
reading a keyword for said video;
compiling a list of all users that are associated with the video, each user in said list having designated the selected video to be in said each user's collection of videos;
analyzing the collection of videos for each user in the list and determining a subset of related videos, said subset of related videos having been designated by at least a specified threshold number of users in said list;
retrieving a set of related keywords from the subset of related videos; and
validating the keyword of the video against the set of related keywords retrieved from the subset of related videos.

13. The apparatus of claim 12, wherein the processor further performs the steps of:
determining that the keyword of said video is not valid; and
generating a set of suggested keywords for replacing the keyword of said video.

14. The apparatus of claim 12, wherein validating the keyword of the video further includes:
determining whether the keyword for said video appears in the set of related keywords retrieved from the subset of related videos.

15. The apparatus of claim 12, wherein retrieving a set of related keywords from the subset of related videos further includes:
setting a metadata correlation threshold; and
compiling keywords which have appeared in the subset of related videos more than the metadata correlation threshold number of times.

16. The apparatus of claim 12, wherein the metadata correlation threshold is a configurable variable.

17. The apparatus of claim 12, wherein the processor further performs the step of:
suggesting alternative metadata to one or more ad engines if the keyword for said video is determined to be invalid, wherein the suggested alternative metadata is based on the set of related keywords.

18. The apparatus of claim 12, wherein the step of determining the subset of related videos is performed independent of any metadata associated with the video.

19. The apparatus of claim 12, wherein the processor further performs the step of:
correlating, with the video, at least one other video such that the metadata of said other video does not match the metadata for said video.

20. The apparatus of claim 12, wherein the collection of videos for each user is designated by the user performing at least one of the following:
adding videos to a favorites list, adding the videos to a channel, adding the videos to a personal play list, reviewing the videos, playing the videos, voting on the videos and rating the videos a specified rating.
